(19) United States
(12) Patent Application Publication
(10) Pub. No.: US 2024/0017670 A1
(43) Pub. Date: Jan. 18, 2024

(54) VEHICULAR EXTERIOR MIRROR SYSTEM WITH MIRROR HEAD POSITION SENSOR

(71) Applicant: Magna Mirrors Holding GmbH, Sailauf (DE)

(72) Inventor: Thibault Martin, Folgensbourg (FR)

(21) Appl. No.: 18/350,191

(22) Filed: Jul. 11, 2023

Related U.S. Application Data
(60) Provisional application No. 63/368,162, filed on Jul. 12, 2022.

(51) Int. Cl. B60R 1/066

(52) U.S. Cl. CPC B60R 1/066

(57) ABSTRACT

A vehicular exterior rearview mirror system includes an exterior rearview mirror assembly having a mirror head pivotable relative to a mounting base. An actuator is operable to adjust the mirror head relative to the mounting base between a folded position and an extended position. The system includes a positioning sensor, a magnetic element, and an electronic control unit (ECU). The positioning sensor collects sensor data representative of a magnetic field of the magnetic element at the positioning sensor. The positioning sensor or the magnetic element is fixed relative to the mounting base and the other is pivotable with the mirror head relative to the mounting base. Based on processing at the ECU of captured sensor data and based on a determined magnetic field at the positioning sensor, the system determines a rotational position of the mirror head relative to the mounting base.

### CROSS REFERENCE TO RELATED APPLICATION

The present application claims the filing benefits of U.S. provisional application Ser. No. 63/368,162, filed Jul. 12, 2022, which is hereby incorporated herein by reference in its entirety.

### FIELD OF THE INVENTION

The present invention relates generally to the field of rearview mirror assemblies for vehicles.

### BACKGROUND OF THE INVENTION

It is known to provide an automotive rearview mirror assembly that includes one or more accessories, such as a light source and/or a user input or the like. The mirror reflective element of such known mirror assemblies include a mirror reflector coating that is vacuum deposited or sputter coated onto a surface of a glass substrate of the mirror reflective element and preferably includes visual indicators such as turn signal indicators and blind zone indicators that indicate to a driver presence of another overtaking vehicle in a side lane adjacent to the equipped vehicle. The exterior rearview mirror may comprise a foldable mirror assembly, such as a powerfold mirror where the mirror head is pivotable between a drive or use position and a folded or park position via operation of an actuator.

### SUMMARY OF THE INVENTION

An exterior rearview mirror system for a vehicle includes an exterior rearview mirror assembly. The exterior rearview mirror assembly includes a mounting arm or base configured for attachment at a side of the vehicle and a mirror head pivotable relative to the mounting arm about a pivot axis. The mirror head may include a mirror casing and a mirror reflective element. An actuator is electrically operable to adjust the mirror head relative to the mounting arm between a folded position, where the mirror head is pivoted in toward the side of the vehicle, and an extended position, where the mirror head is pivoted out from the folded position so that the mirror reflective element provides a view rearward and along the side of the vehicle. The system includes a position sensor, a magnetic target, and an electronic control unit (ECU). The ECU includes electronic circuitry and associated software, such as a data processor for processing sensor data captured by the positioning sensor. The positioning sensor or the magnetic target is fixed relative to the mounting arm and the other is disposed at the mirror head and pivotable relative to the mounting arm with the mirror head. The positioning sensor collects sensor data representative of a magnetic field of the magnetic target at the positioning sensor to determine position of the magnetic target relative to the positioning sensor. Responsive to processing at the ECU of captured sensor data and based on a determined magnetic field of the magnetic target at the positioning sensor (e.g., a determined strength of the magnetic field or a determined magnetic flux density), the system determines a rotational position of the mirror head relative to the mounting arm between the folded position and the extended position.

These and other objects, advantages, purposes and features of the present invention will become apparent upon review of the following specification in conjunction with the drawings.

### BRIEF DESCRIPTION OF THE DRAWINGS

FIG. 1 is a view of an exterior rearview mirror assembly mounted at the side of a vehicle equipped with the vehicular exterior mirror system;

FIGS. 2 and 3 are perspective views of an exterior rearview mirror assembly, showing mounting positions of a sensor at the fixed mounting arm of the mirror assembly and at the pivotable mirror head of the mirror assembly;

FIGS. 4 and 5 are perspective views of an inductive positioning sensor configured to detect the position of a magnetic target disposed about a pivot axis of the mirror assembly;

FIGS. 6-8 are perspective views of a magnetic positioning sensor configured to detect the position of a magnetic target disposed about the pivot axis;

FIGS. 9-13 are perspective views of an optical positioning sensor configured to detect the position of an optical target disposed about the pivot axis;

FIGS. 14-17 are perspective views of a rotating magnetic target fixed relative to the pivot axis of the mirror assembly and a positioning sensor pivotable with the mirror head of the mirror assembly and configured to detect the position of the positioning sensor and mirror head;

FIGS. 18-21 are perspective views of a magnetic target pivotable with the mirror head and a positioning sensor fixed via a bracket to the pivot axis and configured to detect the position of the magnetic target and mirror head;

FIGS. 22-24 are perspective views of a magnetic target fixed at a fixed mounting arm of the mirror assembly and a positioning sensor pivotable with the mirror head and configured to detect the position of the positioning sensor and mirror head, where the magnetic target and positioning sensor are mounted on parallel planes;

FIGS. 25 and 26 are top views of the mirror assembly of FIGS. 22-24;

FIG. 27 is an example graph showing the detection of the magnetic flux density of the magnetic target by a one-dimensional positioning sensor;

FIGS. 28-30 are perspective views of a magnetic target fixed at the fixed mounting arm and a positioning sensor pivotable with the mirror head and configured to detect the position of the positioning sensor and mirror head, where the magnetic target and positioning sensor are mounted on non-parallel planes;

FIGS. 31 and 32 are example graphs showing the detection of the magnetic flux density of the magnetic target by a three-dimensional positioning sensor;

FIGS. 33-36 are perspective views of a magnetic scale fixed about the pivot axis and an incremental encoder pivotable with the mirror head and configured to detect the position of the encoder and mirror head; and

FIGS. 37 and 38 are perspective views of an inductive sensor printed circuit board circumscribing the pivot axis and a magnetic target pivotable with the mirror head and positioned above the inductive sensor printed circuit board to pass along the printed circuit board when the mirror head pivots.

### DESCRIPTION OF THE PREFERRED EMBODIMENTS

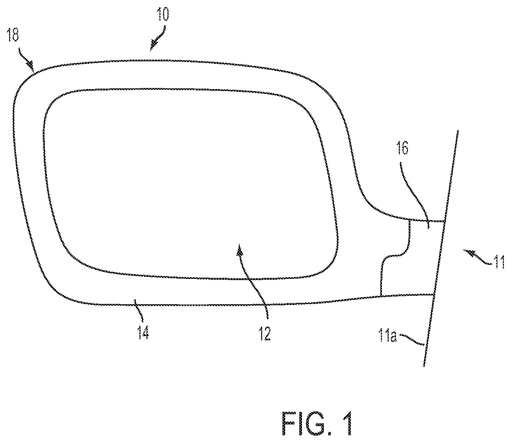

Referring now to the drawings and the illustrative embodiments depicted therein, an exterior rearview mirror assembly 10 for a vehicle 11 includes a mirror reflective element 12 received in and/or supported at or by a mirror shell or casing or head portion 14 (FIG. 1). The mirror casing or head portion 14 may be fixedly attached at a mounting arm or base 16 at the side of the vehicle or may be movably mounted to a mounting arm or base or portion 16, and may comprise a breakaway mirror (where the mirror head portion may be manually pivoted about the mounting arm or base) or may comprise a powerfold mirror (where the mirror head portion may be pivoted via an actuator assembly or adjustment device). The mounting arm or base 16 of the mirror assembly 10 is mounted at the side 11a of a host or subject vehicle 11, with the reflective element 12 providing a rearward field of view along the respective side of the vehicle to the driver of the vehicle, as discussed below.

The mirror assembly comprises a powerfold mirror assembly that includes an actuator that is operable to pivot the mirror head 18 (which includes the mirror casing 14 and the mirror reflective element 12) relative to the mounting arm or base 16. The actuator may be electrically operable in response to a user input and may pivot the mirror head 18 between at least a folded or park position, where the mirror head 18 is pivoted in toward the side of the vehicle so that the mirror reflective element 12 faces the side of the vehicle, and an extended or drive or use position, where the mirror head 18 is pivoted out from the park position so that the mirror reflective element 12 provides the field of view to the driver rearward and along the side of the vehicle. Optionally, the mirror head 18 may be manually pivotable to a forward fold position, where the mirror head 18 is pivoted beyond the drive position, such as upon impact with an object.

With the mirror head 18 in the extended position, the mirror reflective element 12 may be adjustable relative to the mirror casing 14 to adjust the field of view provided by the mirror reflective element 12 to the driver of the vehicle rearward and along the side of the vehicle. Thus, when the mirror head is in the extended position, the mirror head 18 is pivoted to a repeatable position via the actuator, and the mirror reflective element 12 may be separably adjustable relative to the mirror casing 14. Optionally, the mirror reflective element 12 may be fixed relative to the mirror casing 14 and thus, to adjust the field of view provided by the mirror reflective element 12 to the driver of the vehicle, the actuator is further operated to adjust the entire mirror head 18 to adjust the position of the mirror reflective element 12 relative to the driver. Thus, when the mirror head 18 is pivoted to the extended position, the mirror head 18 is further pivotable at the extended position (such as to a lesser degree) to adjust the field of view. For example, the exterior rearview mirror assembly may include characteristics of the mirror assemblies described in U.S. Pat. Nos. 11,396,264; 10,099,618; 9,827,913; 9,487,142; 9,346,403; 9,067,541 and/or 7,887,202, and/or U.S. Publication Nos. US-2023-0009664; US-2022-0126751; US-2020-0353867 and/or US-2020-0223364, which are all hereby incorporated herein by reference in their entireties.

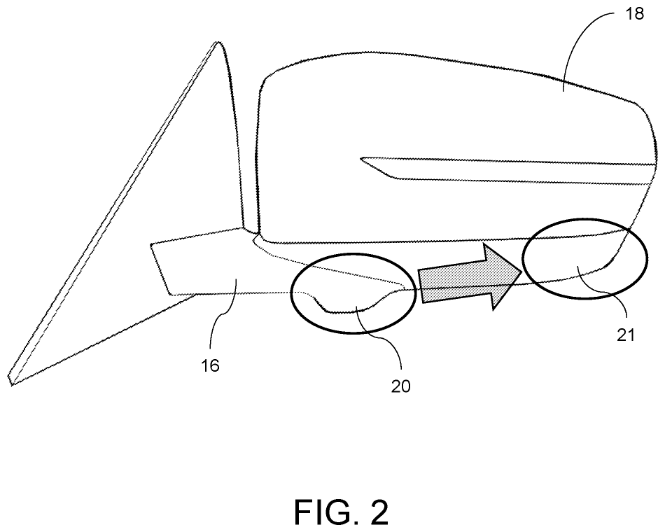

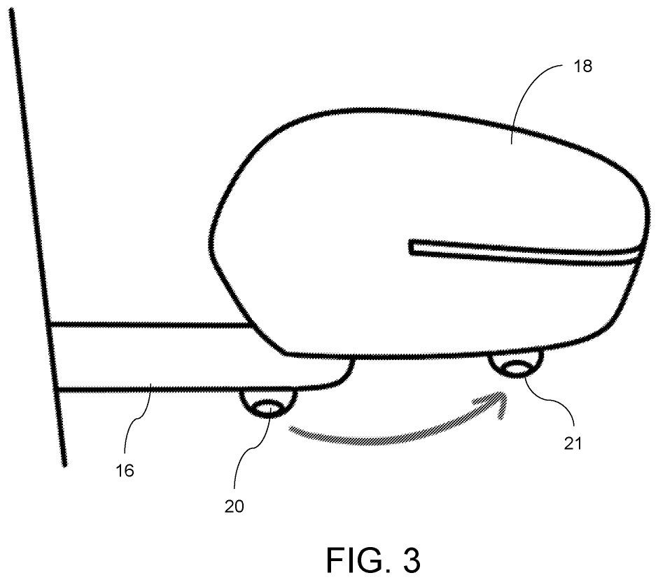

It is known to position sensors, such as cameras used for advanced driver assistance systems (ADAS) and autonomous driving systems, at the exterior rearview mirror assembly. Typically, these sensors are located in the foot or base or mounting arm 16 of the mirror to ensure that their position does not move and the sensors do not return the wrong signals. That is, and as shown in FIGS. 2 and 3, the one or more sensors 20 are typically located in the fixed mounting arm 16 and not at the pivotable mirror head 18 so that, no matter the position of the mirror head 18, the sensor 20 may capture reliable and consistent sensor data. For example, if the mirror head 18 is in the folded position, a sensor at the mirror head would not see the road and could send false information, which is dangerous in an autonomous driving mode.

Positioning a sensor or camera at the pivotable mirror head 18 (such as at position 21 of FIGS. 2 and 3) allows for greater packaging potential (e.g., improved design, aerodynamics, space management for internal components of the mirror, and the like) and reduced obstruction of the field of sensing of the sensor as compared to a position at the mounting arm 16. However, manual and power folding of the mirror head 18 is an issue for the ADAS, which requires accurate information on the origin of the sensor data and position of the sensor at the vehicle. That is, with the sensor disposed at the pivotable mirror head 18, any change in the mirror head position must be precisely detected and the position information transmitted to the electronic control unit (ECU) of the vehicle controlling operation of the ADAS. As described in U.S. Pat. No. 9,487,142 (incorporated above), a mirror head may include a sensor for determining when the mirror head is in one or both of the extended or folded positions. That is, the sensor detects presence of the mirror head if it is in the extended or folded position and is therefore only an ON/OFF solution and does not have adjustment control over the entire mirror rotation range.

To determine the position of one or more sensors at the mirror head 18 relative to the vehicle 11 when the mirror head 18 is between the extended position and the folded position, the mirror assembly 10 includes a positioning measurement system 22 that measures with a high accuracy the precise position of the mirror head 18 in relation to the mounting arm 16, which is fixed to the vehicle 11. Determining the position of the mirror head 18 is important as it includes one or more sensors (such as one or more cameras) and these sensors must be calibrated and in a precise location for ADAS and autonomous or semi-autonomous driving systems. The positioning measurement system 22 determines the position of the mirror head 18 and communicates a position signal to the controller of the vehicle system. Thus, the mirror head position may be considered in processing of captured sensor data for the vehicle system or, if the position of the mirror head is not suitable for the vehicle system, the actuator may be controlled to pivot the mirror head to a suitable position or processing of image data captured by the camera may be adjusted to accommodate for the offset or position of the camera relative to the suitable or default position due to the mirror head position. The positioning measurement system 22 may be adapted to any suitable pivotable exterior rearview mirror design as it provides a simple, compact, inexpensive, and easy to integrate system that provides sufficient accuracy for the cameras and other sensors to function properly. Thus, elements requiring high positioning accuracy (e.g., autonomous surveillance cameras) may be disposed in the movable head of the mirror.

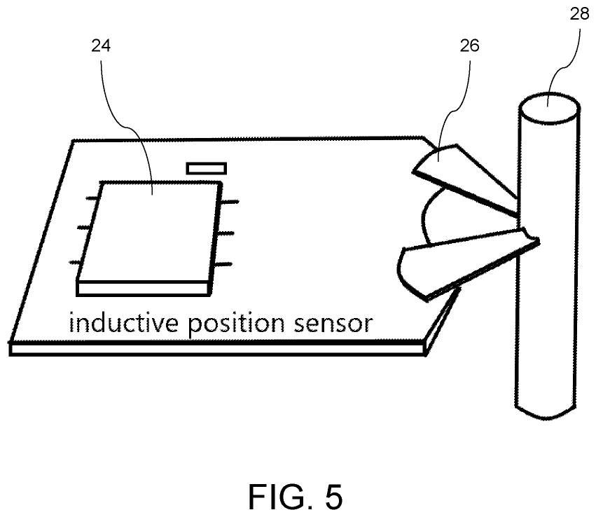

The positioning measurement system 22 may be based on the use of magnetic Hall effect or inductive sensors and the system measures the rotational position of the mirror head 18 about its vertical pivot axis to determine the position of the sensor 20 relative to, for example, the side of the vehicle 11 or the mounting arm 16. The system 22 includes a target element 26, such as a magnet or magnetic element or visual marker, and a positioning sensor 24 for determining the position of the target element 26 relative to the positioning sensor 24, such as a magnetic or inductive or optical sensor (e.g., FIG. 5). One of the target element 26 and the positioning sensor 24 may be positioned at the fixed mounting arm 16 (or another fixed or non-movable portion or region of the vehicle) and the other of the target element 26 and the positioning sensor 24 may be positioned at the pivotable mirror head 18 so that the position of the target element 26 changes in relation to the positioning sensor 24 as the mirror head 18 pivots about the vertical pivot axis relative to the fixed mounting arm 16. The target element 26 and positioning sensor 24 are precisely aligned to ensure accurate measurements. For example, the system 22 may measure the rotational position of the mirror head 18 about its vertical pivot axis with tolerance of less than 5 degrees, such as, for example, 2.5 degrees or less, 1.5 degrees or less, 0.2 degrees or less and the like. As discussed further below, the position of the mirror head may be measured in any suitable way.

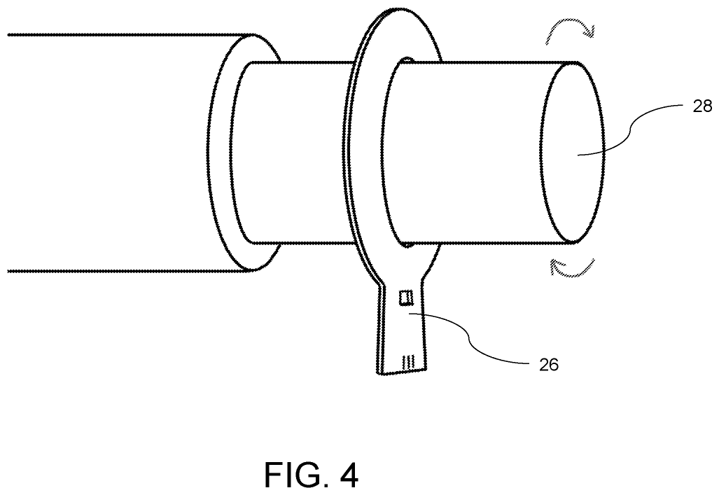

As shown in FIGS. 4-13, the position of the mirror head 18 relative to the mounting arm 16 may be determined using the target element 26 and the positioning sensor 24, where one of the target element 26 and the positioning sensor 24 is fixed to the mirror head 18 to pivot about the pivot axis (e.g., a pivot tube or post 28 of the mirror assembly) with the mirror head 18 and the other of the target element 26 and the positioning sensor 24 is fixed relative to the vehicle to sense movement of the mirror head 18 relative to the vehicle. For example, an inductive positioning sensor 24 may be positioned at the mounting arm 16 relative to a magnetic target element 26 positioned about the pivot tube 28 of the mirror assembly (FIGS. 4 and 5). The inductive positioning sensor 24 may be fixed relative to the side of the vehicle and the magnetic target element 26 may be pivotable with the mirror head 18 so that the inductive positioning sensor 24 determines the rotational position of the magnetic target element 26 as the mirror head 18 pivots about the pivot axis defined by the pivot tube 28 to determine the position of the mirror head and sensor 20 relative to the side of the vehicle 11. For example, the position measurement system may determine the position of the mirror head about the pivot axis based on strength of the magnetic field detected by the positioning sensor 24. As the mirror head moves relative to the mounting arm, the magnetic target element 26 moves relative to the positioning sensor 24 and thus the strength of the magnetic field at the positioning sensor 24 changes according to position of the mirror head relative to the mounting arm.

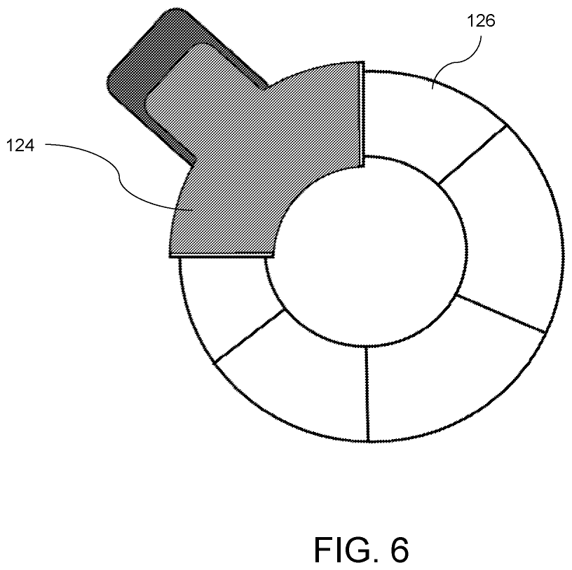

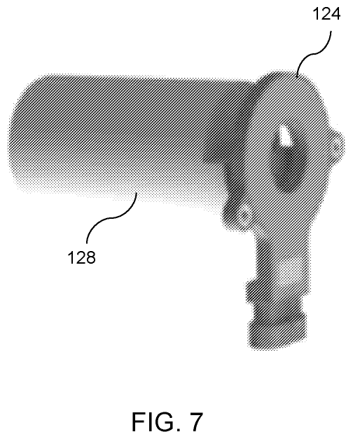

Optionally, a magnetic positioning sensor 124 may be positioned at the mounting arm and a magnetic target element or ring 126 may be positioned about the pivot axis 128 of the mirror assembly (FIGS. 6-8). The positioning sensor 124 may be fixed relative to the mounting arm and the side of the vehicle and the magnetic ring 126 may be pivotable with the mirror head so that the magnetic positioning sensor 124 determines the rotational position of the magnetic ring 126 as the mirror head pivots about the pivot axis defined by the pivot tube 128 to determine the position of the mirror head and sensor relative to the side of the vehicle. For example, and as shown in FIG. 7, the magnetic ring 126 may include segments or portions about the magnetic ring 126 with alternating polarities and the position measurement system may determine the position of the mirror head about the pivot axis based on the detected polarity of the magnetic field at the positioning sensor 124 as the mirror head pivots about the pivot tube 128.

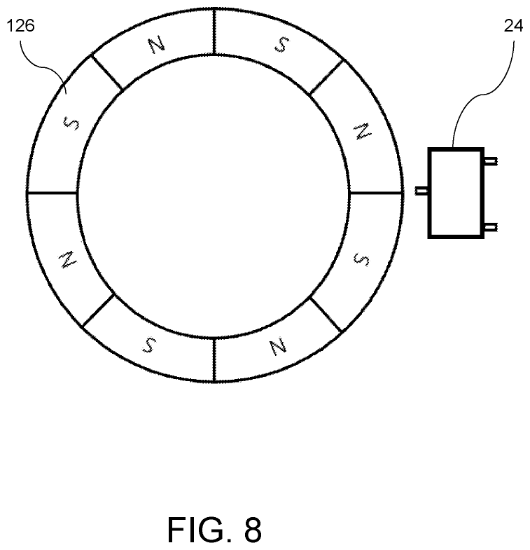

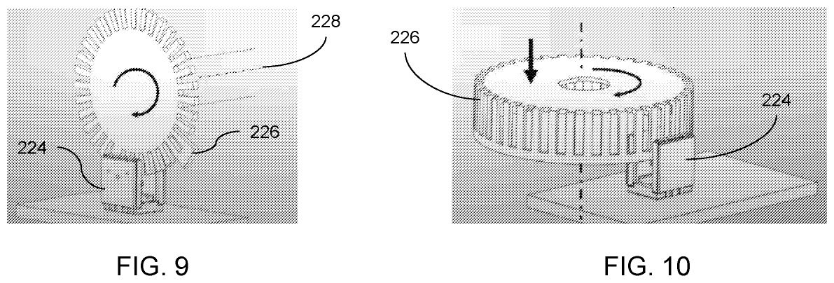

Optionally, an optical sensor 224 may be positioned at the mounting arm and an optical or visual target element 226 may move about the pivot axis 228 according to rotation of the mirror head (FIGS. 9-13). Thus, the optical sensor 224 determines the position of the optical target element 226 as the mirror head pivots about the pivot axis to determine the position of the mirror head and sensor relative to the side of the vehicle. The optical sensor 224 may be positioned perpendicular to the pivot axis 228 above and/or below the target element (FIG. 9), such that the moving target 226 moves above and/or below the optical sensor 224, or the optical sensor 224 may be positioned radially outboard and/or inboard of the target and parallel to the pivot axis 228 (FIG. 10), such that the moving target 226 moves inboard and/or outboard of the optical sensor 224. For example, and as shown in FIGS. 8 and 9, the optical target element 226 may include a plurality of markers or indicators extending radially about the pivot axis so that the markers move past and in view of the optical sensor 224 as the mirror head pivots. The position measurement system may determine the position of the mirror head about the pivot axis based on, for example, the number of markers detected by the optical sensor 224 as the mirror head moves or a current marker detected by the optical sensor 224 at the current position of the mirror head.

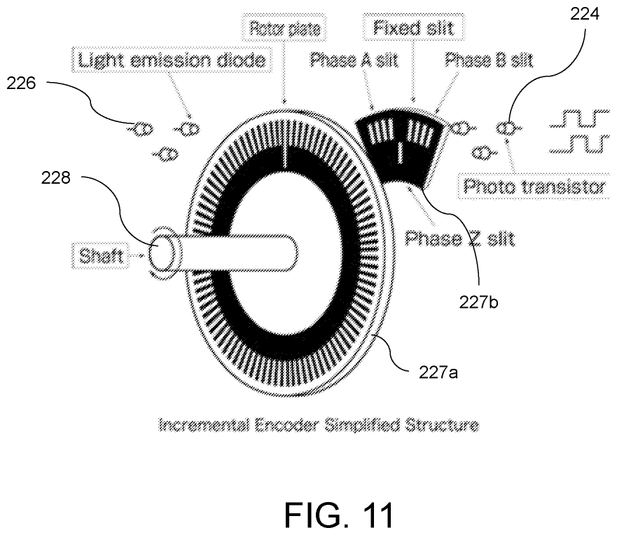

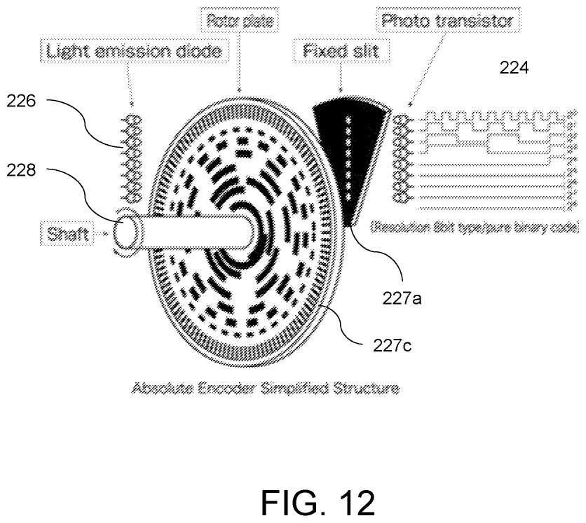

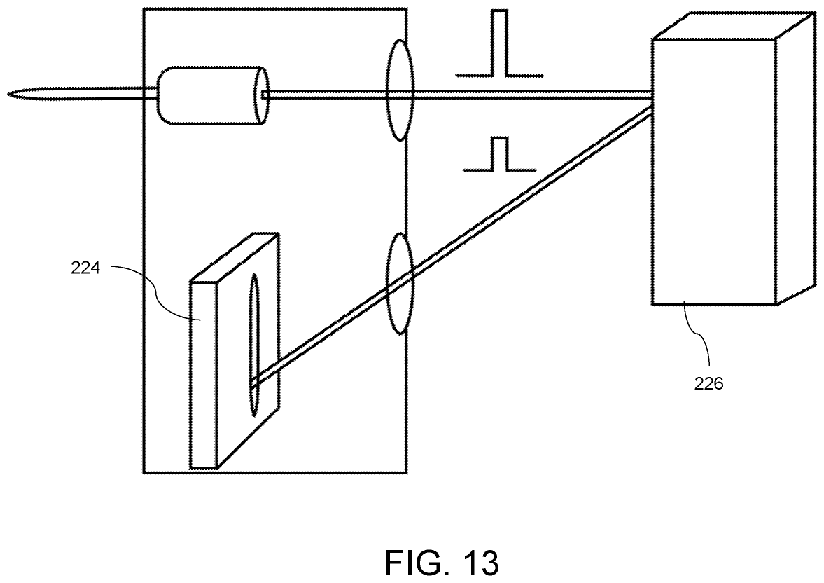

As shown in FIG. 11, the optical sensor 224 may include one or more photo transistors 224 and the optical target element 226 may include one or more light emitting diodes (LEDs) 226, with a fixed slit 227a and an incremental encoder 227b disposed between the LEDs 226 and the photo transistors 224 such that light emitted by the LEDs 226 passes through the fixed slit 227a and the incremental encoder 227b and is detected by the photo transistors 224. The incremental encoder 227b is disposed at a rotor plate rotatable about the pivot axis of the pivot tube 228 so as to rotate or pivot about the pivot axis according to movement of the mirror head. The signal captured by the photo transistors 224 is thus representative of the position of the mirror head about the pivot axis 228. As shown in FIG. 12, an absolute encoder 227c may be disposed between the LEDs 226 and the photo transistors 224 so that light emitted by the LEDs 226 passes through the absolute encoder 227c and the fixed slit 227a to be detected by the photo transistors 224 for determining the position of the mirror head about the pivot tube 228. Optionally, the optical sensor may be a triangulation sensor (FIG. 13).

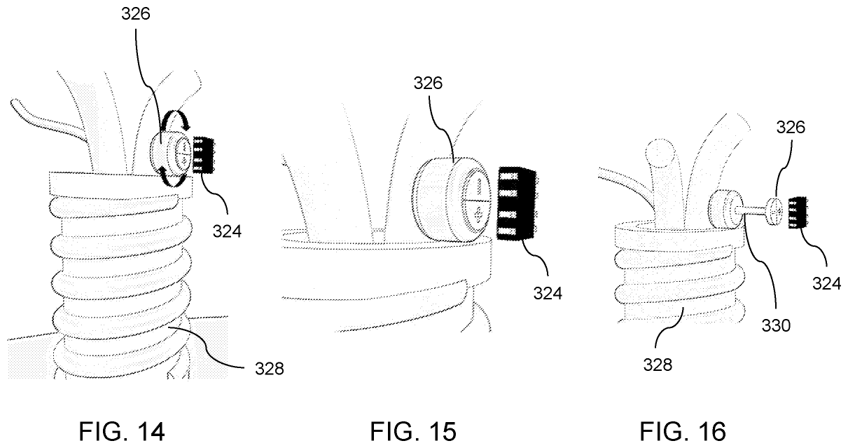

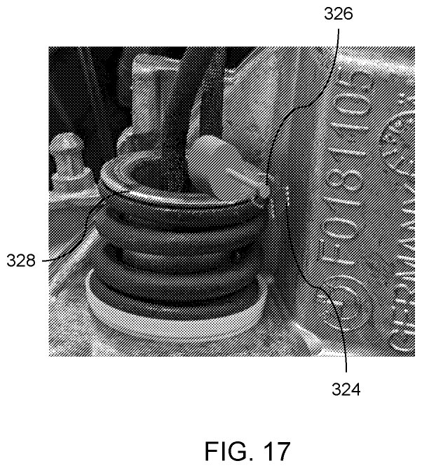

Referring to FIGS. 14-17, a magnetic target 326 may be disposed along the vertical pivot axis of the mirror head, such as within the mirror head and fixed along a pivot tube 328 of the mirror head, with a positioning sensor 324 disposed at the mirror head, such as fixed relative to the mirror head, and movable with the mirror head to sense the position of the magnetic target element 326 to determine the rotational position of the mirror head relative to the vehicle. That is, the magnetic target element 326 is positioned within the mirror head and fixed to the pivot tube 328 about which the mirror head pivots and the positioning sensor 324 is movable with the mirror head so that, as the mirror head pivots relative to the pivot tube and magnetic target element 326, the positioning sensor 324 moves with the mirror head and moves about the fixed magnetic target element 326 and senses the position of the mirror head about the pivot tube 328.

The magnetic target element 326 may be positioned at or near the top end of the pivot tube and rotate on a plane that is parallel to or substantially parallel to the pivot axis to alter the magnetic field as the magnetic target element 326 rotates. In other words, the position of the magnetic target element 326 is fixed relative to the pivot tube 328 and the magnetic target element 326 rotates about an axis perpendicular to the mirror head pivot axis to rotate the magnetic field that the positioning sensor 324 senses. Thus, because the magnetic field is rotating, the positioning sensor 324 is able to determine the position of the mirror head (via measuring changes in the angle or strength of the magnetic field as sensed by the sensor) even when the mirror head is stationary. Optionally, the magnetic target element 326 may be angled (i.e., positioned at an oblique angle) relative to the rotational axis of the mirror to further alter or adjust the magnetic field as the magnetic target element 326 rotates. Optionally, the magnetic target element 326 may be positioned at an end of a rotating axle 330 that extends the magnetic target element 326 a distance from the pivot tube 328 and within the mirror head (e.g., FIG. 16). For example, the magnetic target element 326 may be disposed at a distance away from the pivot tube 328 to align the position of the magnetic target element 326 with a rotational path or path of travel of the positioning sensor 324 as the mirror head pivots. That is, the positioning sensor 324 may be the same distance away from the pivot tube 328 within the mirror head as the magnetic target element 326. Optionally, the magnetic target element 326 may be positioned offset from the path of travel of the positioning sensor 324 (such as inboard, or vertically offset). The positioning sensor 324 is positioned within the mirror head in close proximity to the magnetic target element 326, such as in front of the magnetic target element 326 and vertically oriented parallel to the mirror reflective element.

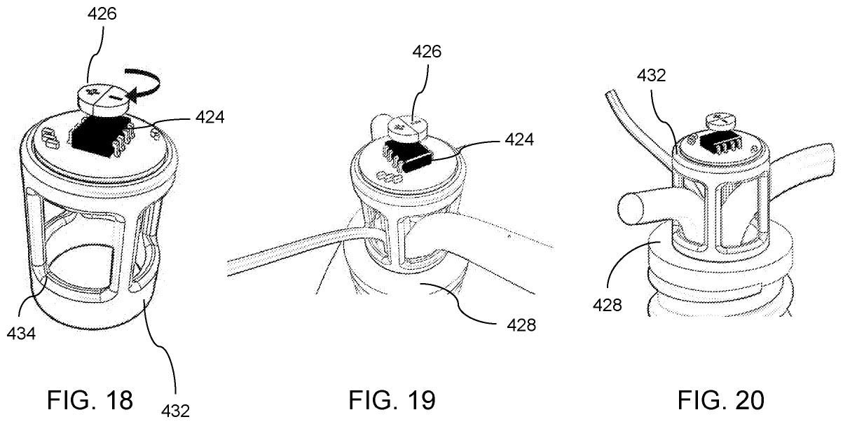

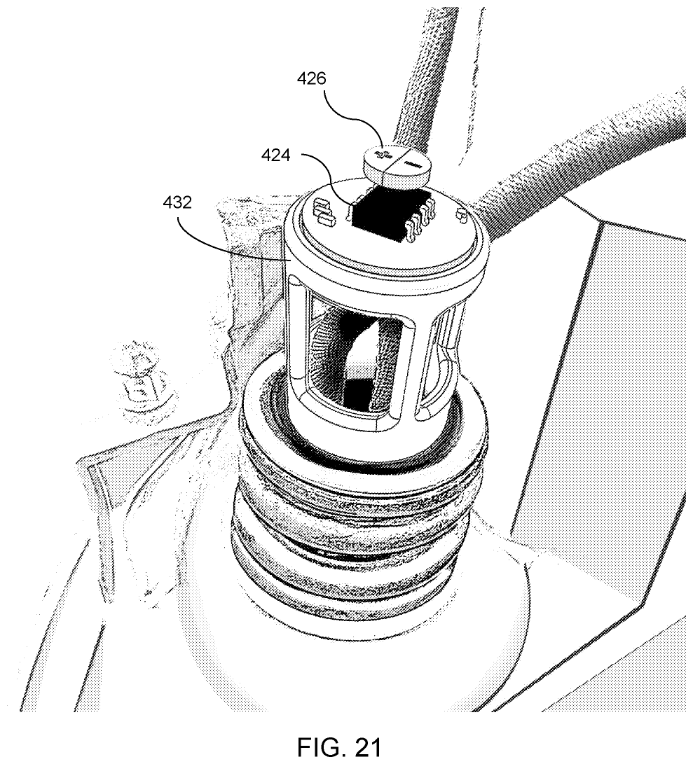

Referring to FIGS. 18-21, a bracket 432 may be fixed relative to the rotation axis, such as fixedly mounted or attached or integrally formed at the upper end of the pivot tube 428, and within the mirror head, with the positioning sensor 424 fixed at the bracket 432 (such as at an upper end or surface of the bracket 432). A magnetic target element 426 is attached at the mirror head and above (such as directly above as shown in FIGS. 18-21) the positioning sensor 424 so that, as the mirror head pivots about the pivot tube 428, the positioning sensor 424 determines the position of the mirror head based on the rotational position of the magnetic target element 426. The magnetic target element 426 does not rotate relative to the mirror head (and only moves/rotates with pivotal movement of the mirror head) so that the magnetic field may be constant except for rotation caused by movement of the mirror head.

In some implementations, the positioning sensor 424 and the magnetic target element 426 may not be aligned with the pivot axis of the mirror head. For example, the magnetic target element 426 may be offset from the pivot axis at a known position within the mirror head relative to the positioning sensor 424. Optionally, the positioning sensor 424 and magnetic target element 426 may be at any suitable angle relative to the pivot axis of the mirror head. As shown in FIGS. 18-21, the positioning sensor 424 may be mounted to an upper end or surface of the bracket 432 that is perpendicular relative to the mirror reflective element.

The bracket 432 may include a mounting portion that mounts to the upper end of the pivot tube 428 and includes an aperture or opening that aligns with a passageway through the pivot tube 428 to allow wires electrically connecting the mirror head to the vehicle to pass from the mirror head, through the aperture of the bracket 432, and along the pivot tube 428. One or more windows 434 between the mounting portion and the upper surface of the bracket 432 may allow the wires to connect between the inner cavity of the mirror head and the pivot tube passageway through the opening of the mounting portion and the one or more windows 434 of the bracket 432.

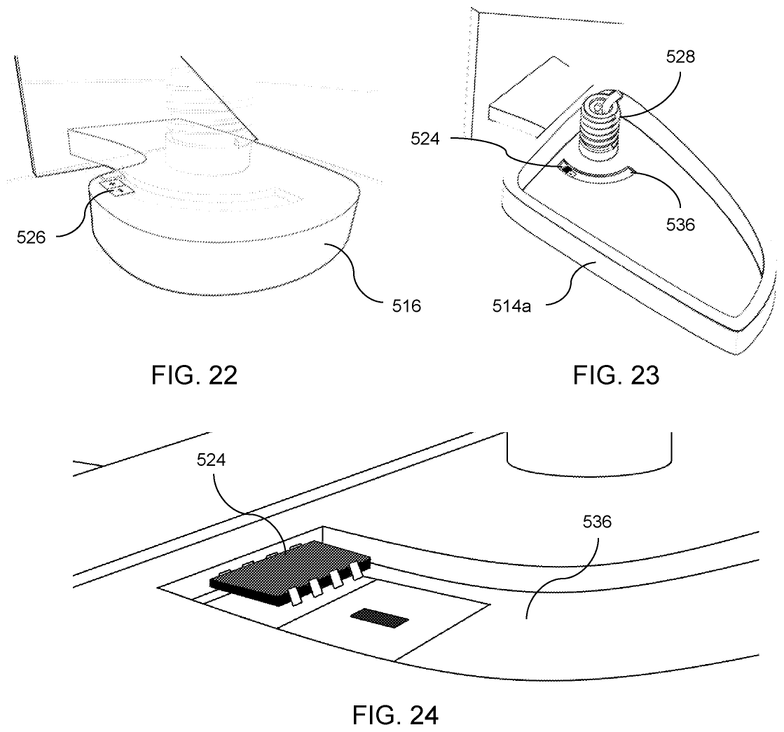

Referring to FIGS. 22-27, in some implementations, neither the target element nor the sensor are directly attached to the pivot tube defining the axis of rotation of the mirror head. Instead, a magnetic target element 526 may be positioned at or within the fixed mounting arm 516 and the positioning sensor 524 may be positioned at or within the pivotable mirror head (such as within a lower portion 514a of the mirror casing) to follow the movement of the mirror head based on the changing position of the positioning sensor 524 relative to the fixed magnetic target element 526 in the mounting arm. The positioning sensor 524 may be positioned within an arcuate gap or recess or channel 536 formed in the lower portion 514a of the mirror casing that faces or abuts the mounting arm 516. The arcuate gap 536 may partially circumscribe the axis of rotation at a distance or radius away from the pivot tube 528. The magnetic target element 526 may be positioned at the mounting arm 516 and aligned with the arcuate gap 536 so that, as the mirror head pivots about the pivot tube 528, the magnetic target element 526 will be positioned along the arcuate gap 536 and the positioning sensor 524 will have a clear line of sight to the magnetic target element 526. Optionally, the arcuate gap 536 may comprise a portion of the lower portion 514a of the mirror casing that is devoid of metallic or magnetic material so that the positioning sensor 524 may sense the magnetic target element 526 through the portion of the mirror casing forming the arcuate gap 536. The system thus determines the position of the mirror head (and location of a camera or sensor of the mirror head) based on the determined position of the magnetic target element or sensor along the arcuate slot or gap 536.

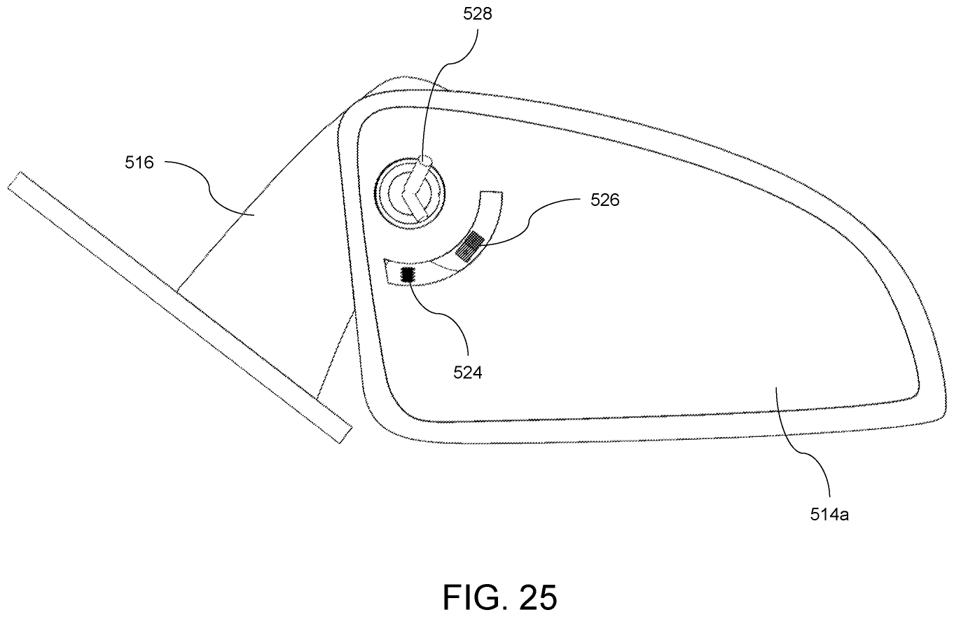

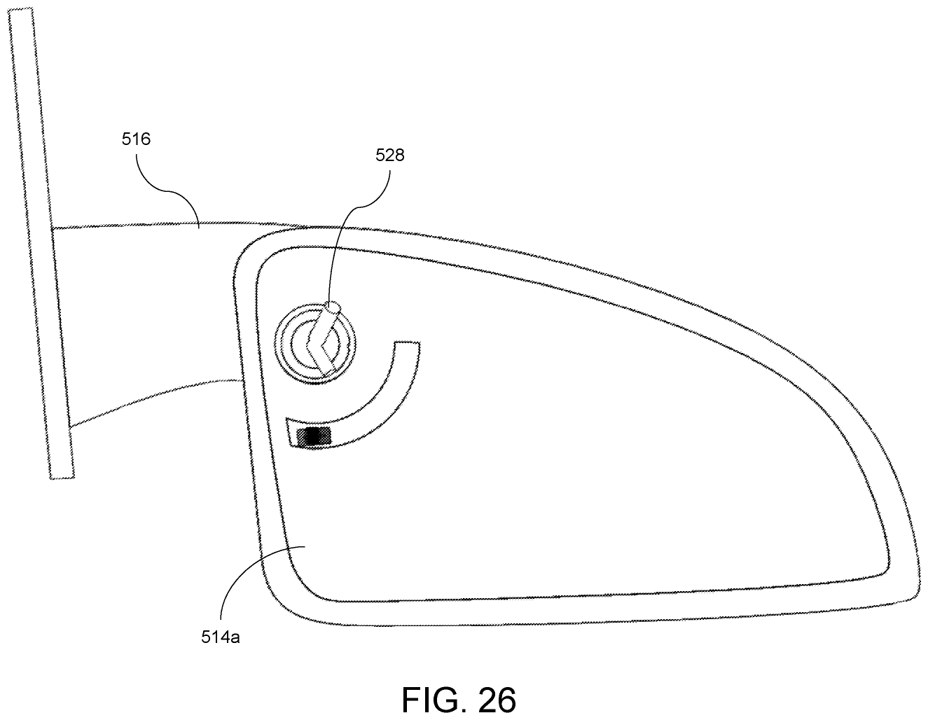

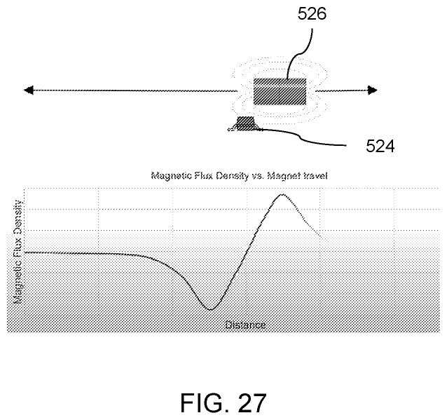

The positioning sensor at the mirror head may comprise any suitable positioning sensor. For example, a one-dimensional (1D) positioning sensor 524 (e.g., a chip or PCB) may detect and measure the magnetic flux density of the magnetic target element 526 moving near the positioning sensor 524 along one axis or direction of movement and the resulting magnetic signal (FIG. 27) provides the precise position over the last few degrees of movement of the mirror head in relation to the mounting arm 516 along the one axis or direction of movement. In FIGS. 22-27, the positioning sensor 524 and the magnetic target element 526 are parallel to one another (i.e., positioned on parallel planes and vertically spaced from one another) so that, as the sensor 524 pivots relative to the magnetic target element 526, the sensor 524 need only determine the relative position of the magnetic target element 526 to the sensor 524 along one axis to determine the rotational positon of the mirror head. In other words, the sensor 524 senses a linear distance between the magnetic target element 526 and the sensor 524 based on the detected magnetic flux density along the one axis or direction of movement to determine the rotational position of the mirror head. For example, and with reference to FIGS. 25 and 26, the sensor 524 may measure the distance traveled by the sensor along an X axis that is parallel to the planes of the sensor 524 and the magnetic target element 526 and along the mounting arm of the mirror assembly (e.g., in a direction generally parallel to a lateral or cross-car axis of the vehicle). Implementations where the sensor and magnetic target element are positioned parallel to one another may be best suited for mirror assemblies where the position of the mirror head is not adjustable relative to the mounting arm 516 in the extended position (i.e., the mirror reflective element is adjusted relative to the mirror casing) as precise measurements of the mirror head positioning along multiple axes are not necessary to determine the position of the camera or sensor. In other words, measurement of the mirror head's positioning along a single axis (e.g., the X axis) is sufficient to determine the position of the ADAS sensor because the mirror head does not independently move along other axes (e.g., a Y axis perpendicular to the X axis and defining a generally horizontal plane with the X axis, or a generally vertical Z axis defining the pivot axis of the mirror head).

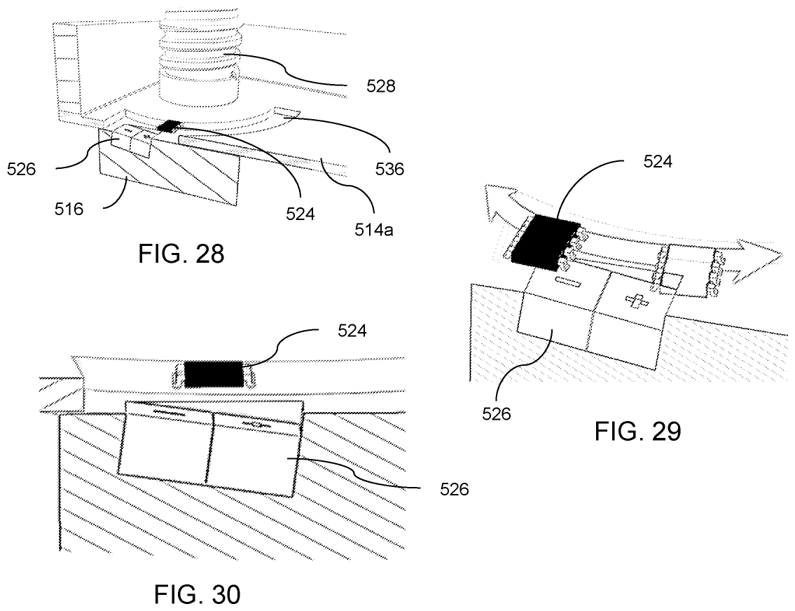

Optionally, and such as shown in FIGS. 28-32, the positioning sensor 524 may be a three-dimensional (3D) positioning sensor that senses the position of the magnetic target element 526 relative to the positioning sensor 524 along multiple axes (e.g., the X, Y, and Z axes shown in FIG. 32) based on detected magnetic flux at the positioning sensor 524 along multiple axes or directions of movement. Implementations where the positioning sensor 524 senses along the X, Y, and Z axes may be best suited when the mirror head is further adjustable from the extended position (i.e., the mirror reflective element is fixed relative to the mirror head) so that, as the mirror head is adjusted to adjust the field of view provided to the driver, the positioning system may determine the adjusted position of the camera or sensor at the mirror head.

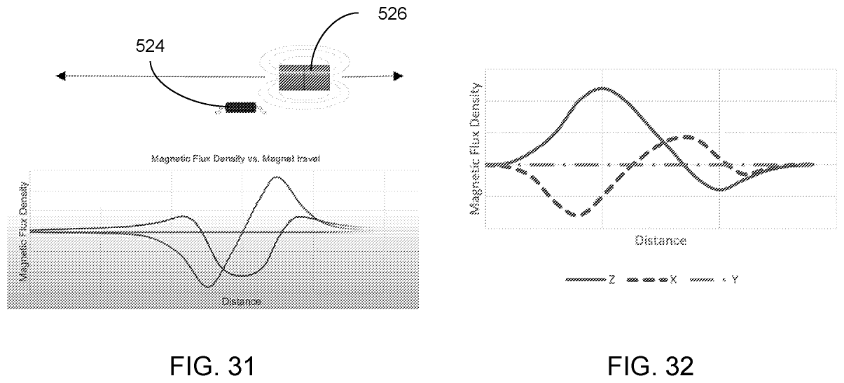

As shown in FIGS. 28-32, the magnetic target element 526 is disposed at the lower portion 514a of the mirror casing and may be tilted relative to the positioning sensor 524 (or the positioning sensor may be tilted relative to the magnet) so that, as the positioning sensor 524 pivots with the mirror head, even if the mirror head is not moved along all axes, the movement of the mirror head along one axis will cause changes in measurements at the positioning sensor 524 along multiple axes. For example, the magnetic target element 526 may be disposed at an oblique angle relative to the positioning sensor 524, such as one degree, five degrees, ten degrees, twenty degrees and the like. Thus, the flux intensity curves detected by the positioning sensor 524 as the mirror head pivots will not be symmetrical, resulting in more precise positioning determinations for the system (FIGS. 31 and 32). In other words, the mounting plane of the magnetic target element 526 may be offset from the mounting plane of the positioning sensor 524 along one or more axes by a known degree and this offset may be considered when determining the position of the mirror head based on the detected position of the magnetic target element 526 relative to the sensor 524.

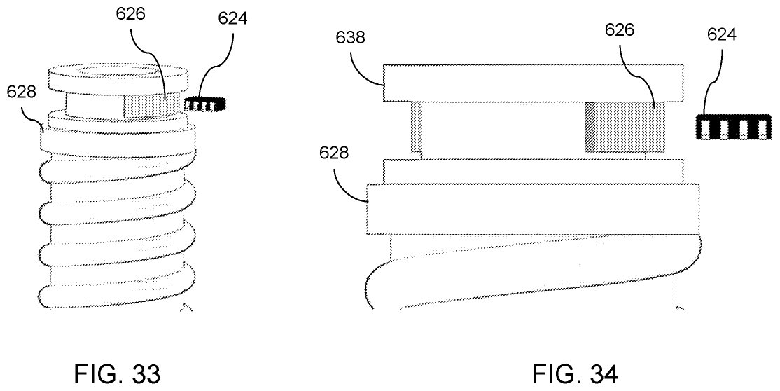

Referring to FIGS. 33-36, in some implementations, the positioning system provides an incremental encoder sensor system. For example, the target element may include a magnetic scale or ring 626 positioned about the pivot axis or pivot tube 628 of the mirror assembly. The magnetic scale 626 may be placed around the pivot tube 628, at an upper end of the pivot tube 628, or in line with the pivot axis of the mirror head. In some implementations, the magnetic scale 626 may be mounted to the pivot tube 628 (such as at the upper end of the pivot tube) via a non-magnetic or non-metallic bracket or mounting portion 638 to isolate the magnetic ring 626 from the metallic pivot tube 628. The mounting portion 638 may attach to the upper end of the pivot tube 628 and include a cylindrical portion about which the magnetic ring 626 is disposed. The cylindrical portion may comprise a different diameter from the pivot tube 628 so that the magnetic ring 626 is disposed closer to the pivot axis than the outer diameter of the pivot tube 628.

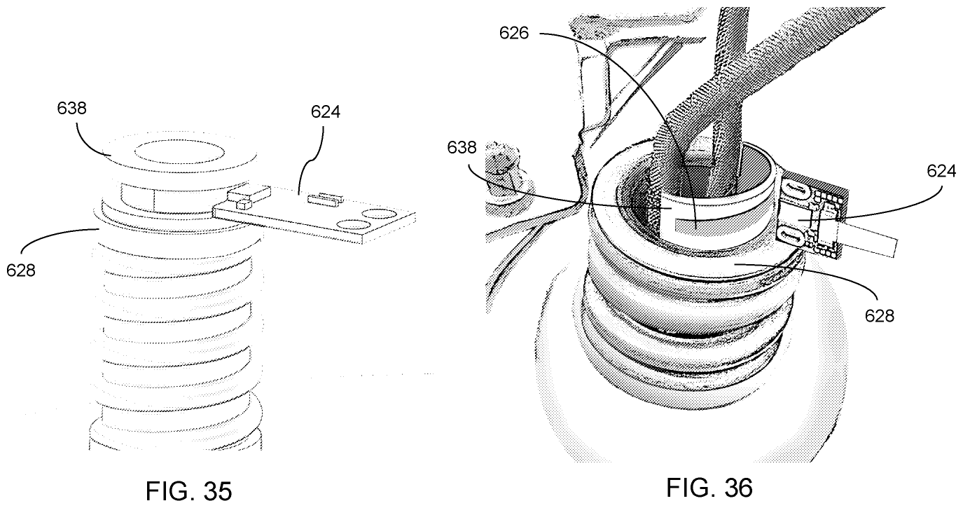

The positioning sensor 624 may be fixed to the mirror head so that, as the mirror head pivots about the pivot tube 628, the positioning sensor 624 pivots about the pivot tube 628 and moves along the magnetic scale 626. The positioning sensor 624 (disposed on a printed circuit board) may be positioned within the mirror head and parallel to the axis of rotation and magnetic scale 626 (FIG. 35) or the positioning sensor 624 may be positioned perpendicular to the axis of rotation and magnetic scale 626 (FIG. 36). The incremental encoder sensor system is designed for a position control loop feedback, particularly in space constraint applications.

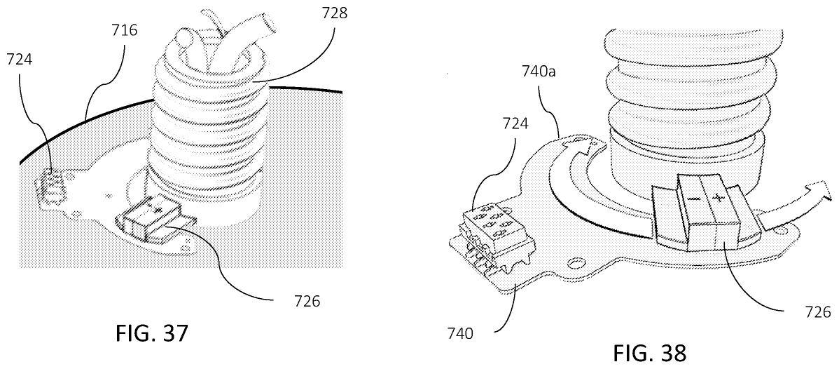

Referring to FIGS. 37 and 38, a circular or arcuate PCB 740 may be disposed at the mounting arm 716 and host an inductive positioning sensor 724. The arcuate PCB 740 may at least partially surround the pivot tube 728 of the mirror head and the magnetic target element 726 is positioned over or along the PCB 740 so that, as the mirror head pivots, the magnetic target element 726 passes along and over the PCB 740 with the positioning sensor 724 detecting the movement of the magnetic target element 726 along the PCB 740. Thus, the magnetic target element need not necessarily be attached directly to the pivot tube 728 or pivot axis and may be placed in the mirror head while following the rotation. The PCB 740 and the magnetic target element 726 may be positioned relative to the mirror head and pivot axis as needed based on space constraints. The PCB 740 has an arcuate portion 740a circumscribing the pivot axis that may be circular (i.e., 360 degrees), 180 degrees, 120 degrees, or less depending on, for example, space constraints and the pivot range of the mirror head.

Thus, the positioning sensor system may determine the position of the mirror head with a positioning sensor and a magnetic target element, where one of the sensor and magnetic target element are fixed relative to the vehicle and the other is pivotable with the mirror head. The system may determine the position along X, Y, and/or Z axes along the full range of motion of the mirror head. Optionally, only the last degrees of rotation may be determined via the positioning sensor, such as to determine a more precise location of the mirror head when the mirror head is near or at the extended or folded position (i.e., a detent position).

The system determines, based on the detected position of the mirror head, whether the ADAS sensor is in an appropriate position to perform an ADAS function of the vehicle (e.g., autonomous or semi-autonomous control of the vehicle while driving). For example, the ADAS system may require that the mirror head be in a fully extended position (or within a threshold distance of the fully extended position) for the ADAS system to receive reliable sensor information from the sensor disposed at the mirror head. Optionally, the positioning system may communicate the determined position of the mirror head so that the ADAS may adjust processing of the captured sensor data based on the determined position, such as to adjust processing of the captured sensor data to accommodate for the determined mirror head position or to distort images (derived from the processed sensor data) for display to the driver of the vehicle. If the mirror head is determined to not be in a correct position (e.g., not at the fully extended position or not within the threshold distance of the fully extended position) or the captured sensor data is determined to not be satisfactory for the ADAS system, the positioning system may operate the actuator to pivot the mirror head until the position of the mirror head is determined to be in the correct or optimal position for the ADAS sensor.

The positioning sensor may comprise any suitable sensor for detecting a position of the target element. For example, an anisotropic magneto resistive (AMR) chip may provide a strong field sensor that follows the target element's stronger magnetic field. The chip therefore measures the changes in the angle of a magnetic field as seen by the sensor.

Further, a resonant inductive position sensor may be used to precisely measure the position of a target without mechanical or electrical contact. The target's position is measured using a sensor built with conventional printed circuit board (PCB) technology. The target houses an electrical resonator comprising an inductor and a capacitor. An electronic processing system interacts with the sensor to power the resonator and to detect the signals that it returns. The detected amplitudes of these signals are processed to determine position.

Thus, the systems are positioned so that one of the two elements (the magnetic target or the sensor) is fixed while the other moves relative to the fixed one as the mirror head pivots or moves. The accuracy and precision of the measurement will depend on the positioning of these two elements in relation to one another. The two elements may therefore be parallel to one another (i.e., on the same or a similar plane) and as close as permitted by space constraints. The closer a path of travel of the magnetic target is to the sensor chip, the better the measurement and the accuracy of the output signal will be.

With the sensor and target placed in the mirror, the system will be fully connected and controlled by the ECU. That is, no human action will be required once installed in the vehicle. The sensor will give the mirror's positional indications so that the system knows if the mirror head position is satisfactory for the mirror's cameras and sensor. If the mirror head is at a different angle relative to the previous open position (when the mirrors have been closed in the meantime), a signal will be sent to the ECU and the actuator will reposition the mirror head by a given or predetermined angle.

The ECU may be accommodated at any suitable position of the vehicle. For example, the ECU may be disposed at the vehicle door and part of a door control module (DCM) of the vehicle. Optionally, the ECU may be disposed at the vehicle body and part of a body control module (BCM). Thus, the DCM and/or the BCM may process the captured sensor data for determining position of the mirror relative to the side of the vehicle or the door and between the extended position and the folded position, and the DCM may control the mirror head actuator to move the mirror head to the extended position or the folded position.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 10,099,618; 9,827,913; 9,487,142; 9,346,403 and/or 8,915,601, which are all hereby incorporated herein by reference in their entireties.

The mirror assembly may comprise any suitable construction, such as, for example, a mirror assembly with the reflective element being nested in the mirror casing and with the mirror casing having a curved or beveled perimeter edge around the reflective element and with no overlap onto the front surface of the reflective element (such as by utilizing aspects of the mirror assemblies described in U.S. Pat. Nos. 7,255,451; 7,289,037; 7,360,932; 8,049,640; 8,277,059 and/or 8,529,108, or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Pat. Nos. 9,827,913; 9,598,016; 9,346,403; 9,174,578; 8,915,601; 8,730,553 and/or 8,508,831, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

The mirror assembly may comprise or utilize aspects of other types of casings or the like, such as described in U.S. Pat. Nos. 7,338,177; 7,289,037; 7,249,860; 6,439,755; 4,826,289 and 6,501,387, which are all hereby incorporated herein by reference in their entireties, without affecting the scope of the present invention. For example, the mirror assembly may utilize aspects of the flush or frameless or bezelless reflective elements described in U.S. Pat. Nos. 7,626,749; 7,360,932; 7,289,037; 7,255,451; 7,274,501 and/or 7,184,190, and/or in U.S. Publication Nos. US-2006-0061008 and/or US-2006-0050018, which are all hereby incorporated herein by reference in their entireties.

Optionally, the mirror assembly may include a camera or imaging sensor (such as a sideward and/or rearward facing imaging sensor or camera that has a sideward/rearward field of view at the side of the vehicle at which the exterior mirror assembly is mounted) that may be part of or may provide an image output for a vehicle vision system, such as a lane departure warning system or object detection system or blind zone alert system or surround view vision system other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. U.S. Pat. Nos. 5,670,935; 5,760,962; 6,498,620; 6,396,397; 6,222,447; 6,201,642; 6,097,023; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, which are all hereby incorporated herein by reference in their entireties. Optionally, for example, the vehicle vision system (utilizing a forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in U.S. Pat. Nos. 10,071,687; 9,834,153; 9,762,880; 9,264,672; 9,126,525; 9,041,806, and/or U.S. Publication No. US-2019-0253672, which are hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror system, the vehicular exterior rearview mirror system comprising:
an exterior rearview mirror assembly comprising (i) a mounting base configured for attachment at a side of a vehicle equipped with the vehicular exterior rearview mirror system, and (ii) a mirror head pivotable relative to the mounting base about a pivot axis;
wherein the mirror head comprises a mirror reflective element;
an electrically-operable actuator, wherein the electrically-operable actuator is electrically operable to adjust the mirror head relative to the mounting base between (i) a folded position, where the mirror head is pivoted in toward the side of the vehicle, and (ii) an extended position, where the mirror head is pivoted out from the folded position so that the mirror reflective elements provides a rearward view to a driver of the vehicle;
a positioning sensor and a magnetic element;
wherein the positioning sensor captures sensor data representative of a magnetic field of the magnetic element at the positioning sensor;
wherein one selected from the group consisting of (i) the positioning sensor is fixed relative to the mounting base and the magnetic element is disposed at the mirror head and pivotable with the mirror head relative to the mounting base and the positioning sensor and (ii) the magnetic element is fixed relative to the mounting base and the positioning sensor is disposed at the mirror head and pivotable with the mirror head relative to the mounting base and the magnetic element;
an electronic control unit (ECU), wherein the ECU comprises electronic circuitry and associated software, and wherein the electronic circuitry comprises a data processor for processing sensor data captured by the positioning sensor;
wherein the vehicular exterior rearview mirror system, based on processing at the ECU of sensor data captured by the positioning sensor, determines a magnetic field of the magnetic element at the positioning sensor; and
wherein the vehicular exterior rearview mirror system, based on processing at the ECU of sensor data captured by the positioning sensor, and based on the determined magnetic field of the magnetic element at the positioning sensor, determines a rotational position of the mirror head relative to the mounting base that is between the folded position and the extended position.

2. The vehicular exterior rearview mirror system of claim 1, wherein a camera is disposed at the mirror head and is operable to capture image data exterior of the vehicle for use by a driving assistance system of the vehicle.

3. The vehicular exterior rearview mirror system of claim 2, wherein, based at least in part on the determined rotational position of the mirror head relative to the mounting base, the vehicular exterior rearview mirror system determines one selected from the group consisting of (i) that the determined rotational position of the mirror head positions the camera for capturing image data for use by the driving assistance system of the vehicle and (ii) that the determined rotational position of the mirror head does not position the camera for capturing image data for use by the driving assistance system of the vehicle.

4. The vehicular exterior rearview mirror system of claim 3, wherein, responsive to determining that the determined rotational position of the mirror head does not position the camera for capturing image data for use by the driving assistance system of the vehicle, the vehicular exterior rearview mirror system operates the electrically-operable actuator to adjust the rotational position of the mirror head until the determined rotational position of the mirror head positions the camera for capturing image data for use by the driving assistance system of the vehicle.

5. The vehicular exterior rearview mirror system of claim 3, wherein the determined rotational position of the mirror head is determined to position the camera for capturing image data for use by the driving assistance system of the vehicle based at least in part on determination that the mirror head is at the folded position or the extended position, and wherein the determined rotational position of the mirror head is determined to not position the camera for capturing image data for use by the driving assistance system of the vehicle based at least in part on determination that the mirror head is not at the folded position or the extended position.

6. The vehicular exterior rearview mirror system of claim 1, wherein the magnetic element is fixed relative to the mounting base and the positioning sensor is disposed at the mirror head and pivotable with the mirror head relative to the mounting base and the magnetic element.

7. The vehicular exterior rearview mirror system of claim 6, wherein, as the mirror head is pivoted between the folded position and the extended position, the positioning sensor moves along a path of travel relative to the magnetic element.

8. The vehicular exterior rearview mirror system of claim 7, wherein the magnetic element is disposed in line with the path of travel of the positioning sensor.

9. The vehicular exterior rearview mirror system of claim 7, wherein the magnetic element is disposed offset from the path of travel of the positioning sensor.

10. The vehicular exterior rearview mirror system of claim 7, wherein a plane of the magnetic element is one selected from the group consisting of (i) parallel relative to the path of travel of the positioning sensor and (ii) perpendicular relative to the path of travel of the positioning sensor.

11. The vehicular exterior rearview mirror system of claim 7, wherein the magnetic element comprises a magnetic scale disposed about the pivot axis, and wherein as the positioning sensor moves along the path of travel, the positioning sensor moves along the magnetic scale.

12. The vehicular exterior rearview mirror system of claim 1, wherein the positioning sensor is fixed relative to the mounting base and the magnetic element is disposed at the mirror head and pivotable with the mirror head relative to the mounting base and the positioning sensor.

13. The vehicular exterior rearview mirror system of claim 12, wherein the positioning sensor and the magnetic element are both disposed along the pivot axis, and wherein, as the mirror head is pivoted between the folded position and the extended position, the magnetic element rotates about the pivot axis relative to the positioning sensor.

14. The vehicular exterior rearview mirror system of claim 12, wherein, as the mirror head is pivoted between the folded position and the extended position, the magnetic element moves along a path of travel relative to the positioning sensor.

15. The vehicular exterior rearview mirror system of claim 14, wherein the positioning sensor comprises an inductive sensor disposed at an inductive printed circuit board, and wherein, as the magnetic element moves along the path of travel, the magnetic element moves along the inductive printed circuit board.

16. The vehicular exterior rearview mirror system of claim 1, wherein the positioning sensor comprises one selected from the group consisting of (i) a magnetic positioning sensor and (ii) an inductive positioning sensor.

17. The vehicular exterior rearview mirror system of claim 1, wherein the vehicular exterior rearview mirror system determines the rotational position of the mirror head relative to the mounting base based on a determined magnetic flux density at the positioning sensor.

18. The vehicular exterior rearview mirror system of claim 1, wherein the mirror head accommodates the electrically-operable actuator.

19. The vehicular exterior rearview mirror system of claim 1, wherein, responsive to determining that the determined rotational position of the mirror head is not at the folded position or the extended position, the vehicular exterior rearview mirror system operates the electrically-operable actuator to adjust the rotational position of the mirror head until the determined rotational position of the mirror head is at the folded position or the extended position.

20. A vehicular exterior rearview mirror system, the vehicular exterior rearview mirror system comprising:
an exterior rearview mirror assembly comprising (i) a mounting base configured for attachment at a side of a vehicle equipped with the vehicular exterior rearview mirror system, and (ii) a mirror head pivotable relative to the mounting base about a pivot axis;
wherein the mirror head comprises a mirror reflective element;
wherein a camera is disposed at the mirror head and is operable to capture image data exterior of the vehicle for use by a driving assistance system of the vehicle;
an electrically-operable actuator, wherein the electrically-operable actuator is electrically operable to adjust the mirror head relative to the mounting base between (i) a folded position, where the mirror head is pivoted in toward the side of the vehicle, and (ii) an extended position, where the mirror head is pivoted out from the folded position so that the mirror reflective elements provides a rearward view to a driver of the vehicle;
a positioning sensor and a magnetic element;
wherein the positioning sensor captures sensor data representative of a magnetic field of the magnetic element at the positioning sensor;
wherein the positioning sensor is fixed relative to the mounting base and the magnetic element is disposed at the mirror head and pivotable with the mirror head relative to the mounting base and the positioning sensor;
an electronic control unit (ECU), wherein the ECU comprises electronic circuitry and associated software, and wherein the electronic circuitry comprises a data processor for processing sensor data captured by the positioning sensor;
wherein the vehicular exterior rearview mirror system, based on processing at the ECU of sensor data captured by the positioning sensor, determines a magnetic field of the magnetic element at the positioning sensor;
wherein the vehicular exterior rearview mirror system, based on processing at the ECU of sensor data captured by the positioning sensor, and based on the determined magnetic field of the magnetic element at the positioning sensor, determines a rotational position of the mirror head relative to the mounting base that is between the folded position and the extended position; and
wherein, responsive to determining that the determined rotational position of the mirror head is not at the folded position or the extended position, the vehicular exterior rearview mirror system operates the electrically-operable actuator to adjust the rotational position of the mirror head until the determined rotational position of the mirror head is at the folded position or the extended position.

21. The vehicular exterior rearview mirror system of claim 20, wherein the positioning sensor and the magnetic element are both disposed along the pivot axis, and wherein, as the mirror head is pivoted between the folded position and the extended position, the magnetic element rotates about the pivot axis relative to the positioning sensor.

22. The vehicular exterior rearview mirror system of claim 20, wherein, as the mirror head is pivoted between the folded position and the extended position, the magnetic element moves along a path of travel relative to the positioning sensor.

23. The vehicular exterior rearview mirror system of claim 22, wherein the positioning sensor comprises an inductive sensor disposed at an inductive printed circuit board, and wherein, as the magnetic element moves along the path of travel, the magnetic element moves along the inductive printed circuit board.

24. The vehicular exterior rearview mirror system of claim 20, wherein the positioning sensor comprises one selected from the group consisting of (i) a magnetic positioning sensor and (ii) an inductive positioning sensor.

25. The vehicular exterior rearview mirror system of claim 20, wherein the mirror head accommodates the electrically-operable actuator.

26. A vehicular exterior rearview mirror system, the vehicular exterior rearview mirror system comprising:
an exterior rearview mirror assembly comprising (i) a mounting base configured for attachment at a side of a vehicle equipped with the vehicular exterior rearview mirror system, and (ii) a mirror head pivotable relative to the mounting base about a pivot axis;
wherein the mirror head comprises a mirror reflective element;
an electrically-operable actuator, wherein the electrically-operable actuator is electrically operable to adjust the mirror head relative to the mounting base between (i) a folded position, where the mirror head is pivoted in toward the side of the vehicle, and (ii) an extended position, where the mirror head is pivoted out from the folded position so that the mirror reflective elements provides a rearward view to a driver of the vehicle;
wherein the mirror head accommodates the electrically-operable actuator;
a positioning sensor and a magnetic element;
wherein the positioning sensor captures sensor data representative of a magnetic field of the magnetic element at the positioning sensor;
wherein the magnetic element is fixed relative to the mounting base and the positioning sensor is disposed at the mirror head and pivotable with the mirror head relative to the mounting base and the magnetic element;
wherein, as the mirror head is pivoted between the folded position and the extended position, the positioning sensor moves along a path of travel relative to the magnetic element;
an electronic control unit (ECU), wherein the ECU comprises electronic circuitry and associated software, and wherein the electronic circuitry comprises a data processor for processing sensor data captured by the positioning sensor;
wherein the vehicular exterior rearview mirror system, based on processing at the ECU of sensor data captured by the positioning sensor, determines a magnetic field of the magnetic element at the positioning sensor;
wherein the vehicular exterior rearview mirror system, based on processing at the ECU of sensor data captured by the positioning sensor, and based on the determined magnetic field of the magnetic element at the positioning sensor, determines a rotational position of the mirror head relative to the mounting base that is between the folded position and the extended position; and
wherein, responsive to determining that the determined rotational position of the mirror head is not at the folded position or the extended position, the vehicular exterior rearview mirror system operates the electrically-operable actuator to adjust the rotational position of the mirror head until the determined rotational position of the mirror head is at the folded position or the extended position.

27. The vehicular exterior rearview mirror system of claim 26, wherein a camera is disposed at the mirror head and is operable to capture image data exterior of the vehicle for use by a driving assistance system of the vehicle.

28. The vehicular exterior rearview mirror system of claim 27, wherein, based at least in part on the determined rotational position of the mirror head relative to the mounting base, the vehicular exterior rearview mirror system determines one selected from the group consisting of (i) that the determined rotational position of the mirror head positions the camera for capturing image data for use by the driving assistance system of the vehicle and (ii) that the determined rotational position of the mirror head does not position the camera for capturing image data for use by the driving assistance system of the vehicle, and wherein, responsive to determining that the determined rotational position of the mirror head does not position the camera for capturing image data for use by the driving assistance system of the vehicle, the vehicular exterior rearview mirror system operates the electrically-operable actuator to adjust the rotational position of the mirror head until the determined rotational position of the mirror head positions the camera for capturing image data for use by the driving assistance system of the vehicle.

29. The vehicular exterior rearview mirror system of claim 26, wherein the magnetic element is disposed in line with the path of travel of the positioning sensor.

30. The vehicular exterior rearview mirror system of claim 26, wherein the magnetic element is disposed offset from the path of travel of the positioning sensor.

31. The vehicular exterior rearview mirror system of claim 26, wherein the magnetic element comprises a magnetic scale disposed about the pivot axis, and wherein as the positioning sensor moves along the path of travel, the positioning sensor moves along the magnetic scale.
